(19) United States
(12) Patent Application Publication
(10) Pub. No.: US 2024/0185124 A1
(43) Pub. Date: Jun. 6, 2024

(54) LEARNING DEVICE, STRESS ESTIMATION DEVICE, LEARNING METHOD, STRESS ESTIMATION METHOD, AND STORAGE MEDIUM

(71) Applicant: NEC Corporation, Minato-ku, Tokyo (JP)

(72) Inventors: Masanori TSUJIKAWA, Tokyo (JP); Tasuku Kitade, Tokyo (JP); Yoshiki NAKASHIMA, Tokyo (JP); Terumi Umematsu, Tokyo (JP); Kei Shibuya, Tokyo (JP); Azusa Furukawa, Tokyo (JP)

(73) Assignee: NEC Corporation, Minato-ku, Tokyo (JP)

(21) Appl. No.: 18/284,929

(22) PCT Filed: Apr. 2, 2021
(86) PCT No.: PCT/JP2021/014357

§ 371 Date: Sep. 29, 2023

(51) Int. Cl. G06N 20/00

(52) U.S. Cl. CPC G06N 20/00

(57) ABSTRACT

An information processing device 1X mainly includes first and sorting means 14X and 15X, a feature value selection means 16X, and a learning means 17X. The first sorting means 14X performs a first sorting for sorting observation feature values of a target person based on attribute and/or environment of the target person. The second sorting means 15X performs a second sorting for sorting the observed feature values based on an observation target of the observed feature values and/or an activity state of the target person. The feature value selection means 16X selects stress estimation feature values for stress estimation from the observed feature values sorted based on the first sorting and the second sorting. The learning means 17X trains a stress estimation model based on the stress estimation feature values and corresponding correct stress values for each cluster of the observed feature values sorted by the first sorting.

### TECHNICAL FIELD

The present disclosure relates to a technical field of a learning device, a stress estimation device, a learning method, a stress estimation method, and a storage medium configured to perform processing related to estimation of a stress state.

### BACKGROUND

There is a device or a system for determining a stress state of a subject based on data measured from the subject. For example, Patent Literature 1 discloses a portable stress measuring device which determines a temporary stress degree of an estimation target person on each day based on biological data of an estimation target person.

### CITATION LIST

### Patent Literature

Patent Literature 1: JP 2007-275287A

### SUMMARY

### Problem to be Solved

When estimating the stress level of a subject from the biological data of the subject, there was an issue that the estimation accuracy for unknown data was not stable.

In view of the above-described issues, it is an object of the present disclosure to provide a learning device, a stress estimation device, a learning method, a stress estimation method, and a storage medium configured to perform processing to obtain a stress estimation result with a stable estimation accuracy.

### Means for Solving the Problem

In one aspect of the learning device, there is provided a learning device including:
a first sorting means configured to perform a first sorting for sorting observation feature values of a target person based on at least one of an attribute and/or environment of the target person;
a second sorting means configured to perform a second sorting for sorting the observed feature values based on at least one of an observation target of the observed feature values and/or an activity state of the target person;
a feature value selection means configured to select stress estimation feature values, which are feature values to be used for stress estimation, from the observed feature values sorted based on the first sorting and the second sorting; and
a learning means configured to train a stress estimation model based on the stress estimation feature values and stress values that are correct answer corresponding to the stress estimation feature values, at least for each of clusters into which the observed feature values are sorted by the first sorting.

In one aspect of the stress estimation device, there is provided a stress estimation device including:
a classification means configured to classify observed feature values of an estimation target person subject to stress estimation, based on at least one of an attribute and/or an environment of the estimation target person;
a feature value selection means configured to select stress estimation feature values, which are used for stress estimation, from the observed feature values, based on the classification; and
a stress estimation means configured to
   select a stress estimation model based on the classification and
   input the stress estimation feature values to the selected stress estimation model to estimate a stress value of the estimation target person.

In one aspect of the learning method, there is provided a learning method executed by a computer, the learning method including:
performing a first sorting for sorting observation feature values of a target person based on at least one of an attribute and/or environment of the target person;
performing a second sorting for sorting the observed feature values based on at least one of an observation target of the observed feature values and/or an activity state of the target person;
selecting stress estimation feature values, which are feature values to be used for stress estimation, from the observed feature values sorted based on the first sorting and the second sorting; and
training a stress estimation model based on the stress estimation feature values and stress values that are correct answer corresponding to the stress estimation feature values, at least for each of clusters into which the observed feature values are sorted by the first sorting. It is noted that the term “computer” herein includes any electronic device (which includes a processor incorporated in the electronic device) and may be configured by a plurality of electronic devices.

In one aspect of the stress estimation method, there is provided a stress estimation method including:
classifying observed feature values of an estimation target person subject to stress estimation, based on at least one of an attribute and/or an environment of the estimation target person;
selecting stress estimation feature values, which are used for stress estimation, from the observed feature values, based on the classification; and
selecting a stress estimation model based on the classification and inputting the stress estimation feature values to the selected stress estimation model to estimate a stress value of the estimation target person.

In one aspect of the storage medium, there is provided a storage medium storing a program executed by a computer, the program causing the computer to:
perform a first sorting for sorting observation feature values of a target person based on at least one of an attribute and/or environment of the target person;
perform a second sorting for sorting the observed feature values based on at least one of an observation target of the observed feature values and/or an activity state of the target person;
select stress estimation feature values, which are feature values to be used for stress estimation, from the observed feature values sorted based on the first sorting and the second sorting; and
train a stress estimation model based on the stress estimation feature values and stress values that are correct answer corresponding to the stress estimation feature values, at least for each of clusters into which the observed feature values are sorted by the first sorting.

In one aspect of the storage medium, there is provided a storage medium storing a program executed by a computer, the program causing the computer to:
classify observed feature values of an estimation target person subject to stress estimation, based on at least one of an attribute and/or an environment of the estimation target person;
select stress estimation feature values, which are used for stress estimation, from the observed feature values, based on the classification; and
select a stress estimation model based on the classification and input the stress estimation feature values to the selected stress estimation model to estimate a stress value of the estimation target person.

### Effect

An example advantage according to the present invention is to estimate stress with a stable estimation accuracy, or, to acquire a learned stress estimation model to achieve such stress estimation.

### BRIEF DESCRIPTION OF THE DRAWINGS

FIG. 1 It illustrates a schematic configuration of a stress estimation system according to a first example embodiment.

FIG. 2 It illustrates an example of a hardware configuration of a stress estimation device common to each example embodiment.

FIG. 3 It illustrates an example of functional blocks in the learning phase of the information processing device according to the first example embodiment.

FIG. 4 It illustrates an example of functional blocks of the feature value selection unit.

FIG. 5 It illustrates a histogram which aggregates the correlations for a certain type of observed feature values.

FIG. 6 It is a diagram showing the timing of conducting stress questionnaires for measuring the PSS value during the measuring period of the observation data regarding a certain sample target person.

FIG. 7 It is an example of a flowchart illustrating a procedure of a learning process that is executed by an information processing device in a learning phase according to the first example embodiment.

FIG. 8 It illustrates an example of functional blocks in the estimation phase of the information processing device according to the first example embodiment.

FIG. 9 It is an example of a flowchart illustrating a procedure of a stress estimation process that is executed by the information processing device in the estimation phase according to the first example embodiment.

FIG. 10 It illustrates a schematic configuration of a stress estimation system in a second example embodiment.

FIG. 11 It is a block diagram of a learning device in a third example embodiment.

FIG. 12 It illustrates an example of a flowchart executed by the learning device in the third example embodiment.

### EXAMPLE EMBODIMENTS

Hereinafter, example embodiments of a learning device, a stress estimation device, a learning method, a stress estimation method, and a storage medium will be described with reference to the drawings.

### First Example Embodiment

### (1) System Configuration

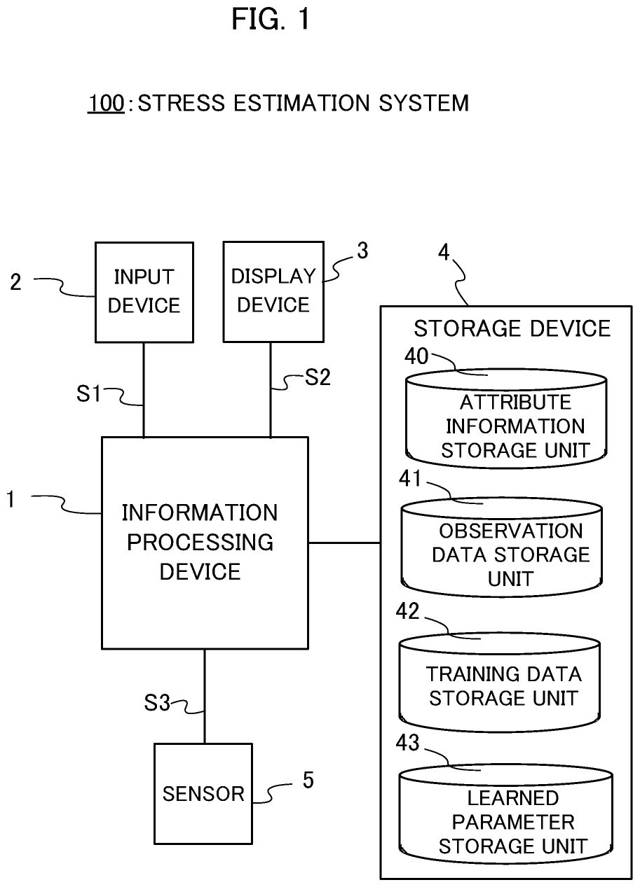

FIG. 1 shows a schematic configuration of a stress estimation system 100 according to a first example embodiment. The stress estimation system 100 performs learning of a model (also referred to as “stress estimation model”) to estimate the stress of a person, and performs stress estimation based on the learned estimation model. Hereafter, the person subject to stress estimation is referred to as “estimation target person”, and the person subject to measurement to generate training data (training sample) necessary for the learning of stress estimation model is also referred to as “sample target person”. In addition, when the estimation target person and the sample target person are not distinguished in particular, these are simply referred to as “target person”. The “estimation target person” may be a sports player or an employee whose stress state is managed by the organization, or may be an individual user.

The stress estimation system 100 mainly includes an information processing device 1, an input device 2, a display device 3, a storage device 4, and a sensor 5.

The information processing device 1 performs data communication with the input device 2, the display device 3, and the sensor 5 through a communication network or through wireless or wired direct communication. Based on the input signal “S1” supplied from the input device 2 and the sensor signal “S3” supplied from the sensor 5, the information processing device 1 collects information required for training the stress estimation model or for estimating the stress of the estimation target person using the stress estimation model, and stores the collected information in the storage device 4. Further, the information processing device 1 generates the display signal “S2” based on the estimated result of the stress state of the estimation target person (specifically, the stress value representing the degree of stress), and supplies the generated display signal S2 to the display device 3. It is noted that the stress estimated by the information processing device 1 in the present example embodiment is assumed to be a chronic stress which is a stress in a long-term (chronic) perspective on a several-days, weekly or monthly basis.

The input device 2 is one or more interfaces configured to receive user input (manual input) of information regarding each estimation target person. The user who inputs information using the input device 2 may be the estimation target person itself or may be a person who manages or supervises the activity of the estimation target person. Examples of the input device 2 include a variety of user input interfaces such as a touch panel, a button, a keyboard, a mouse, and a voice input device. The input device 2 supplies the input signal S1 generated based on the input from the user to the information processing device 1. The display device 3 displays information based on the display signal S2 supplied from the information processing device 1. Examples of the display device 3 include a display and a projector.

The sensor 5 measures a biological signal or the like of the estimation target person and supplies the measured biological signal or the like to the information processing device 1 as a sensor signal S3. In this instance, the sensor signal S3 may be any biological signal (including vital information) such as heartbeat, EEG, amount of perspiration, amount of hormonal secretion, cerebral blood flow, blood pressure, body temperature, electromyogram, electrocardiogram, respiration rate, pulse wave, acceleration regarding estimation target person. The sensor 5 may be a device that analyzes blood of the estimation target person and outputs the analysis result as a sensor signal S3. The sensor 5 may be a wearable terminal worn by the estimation target person, or may be a camera for photographing the object person or a microphone for generating a voice signal of the estimation target person's utterance. The sensor 5 may be a terminal such as a personal computer and a smartphone operated by the estimation target person. In this instance, the sensor 5 may supply information corresponding to the operation quantity of the personal computer or the smart phone to the information processing device 1 as the sensor signal S3. The sensor 5 may output the position information outputted by a GPS receiver or the like incorporated in the wearable terminal or the like as the sensor signal S3. The sensor signal S3 is used to generate feature values (also referred to as “observed feature values”) representing the observed features of an observed target person.

The storage device 4 is a memory configured to store various information necessary for estimating the stress state. The storage device 4 may be an external storage device, such as a hard disk, connected to or embedded in the information processing device 1, or may be a storage medium such as a flash memory. The storage device 4 may be a server device that performs data communication with the information processing device 1. Further, the storage device 4 may be configured by a plurality of devices.

The storage device 4 includes an attribute information storage unit 40, an observation data storage unit 41, a training data storage unit 42, and a learned parameter storage unit 43.

The attribute information storage unit 40 stores the attribute information relating to the attribute of the subject. Here, the term “attribute” herein includes, for example, the personality of a target person, the stress tolerance, the gender, the job type, the age, the perception tendency, and a combination thereof. The attribute information may be generated by the information processing device 1 and stored in the storage device 4, or may be generated in advance by a device other than the information processing device 1 and stored in the storage device 4. The attribute information may include information generated based on the results of the questionnaire answered by the target person. Examples of the questionnaire to measure the personality of a target person include the Big Five personality test. The attribute information is associated with the identification information regarding the target person and is stored in the attribute information storage unit 40.

The observation data storage unit 41 stores observation data generated based on the sensor signal S3 or the like which the information processing device 1 acquires from the sensor 5. In the present example embodiment, for example, the observation data is information in which observed feature values are associated with environmental information indicating an environment such as the observation time and date and the observation place, activity information indicating the activity state of the target person at the time of the observation, and identification information regarding the target person, wherein examples of the activity state include the intensity of physical exercise, the intensity of mental activity such as a mental workload, a state of sitting, walking, or running, a state of awaking or sleeping. For convenience of explanation, it is assumed that the observation data storage unit 41 stores the observation data regarding estimation target person(s), and the training data storage unit 42 stores the observation data regarding sample target person(s).

The observed feature values are values of arbitrary features representing features of data observed from a target person, and examples of the observed feature values include feature values based on a biological feature such as amount of perspiration, acceleration, skin temperature, and pulse wave, and feature values based on a behavioral feature based on an activity (action) of the target person such as an amount of operating a device. Here, the process of converting the sensor signal S3 into the observed feature value may be executed by the information processing device 1, or may be executed by a device other than the information processing device 1. In this case, the observed feature value may be generated from the sensor signal S3 based on any method of calculating feature values from a biological signal or any other method. The environmental information is generated by the information processing device 1 or another device based on, for example, date and time information, position information, temperature and humidity information, carbon dioxide concentration information, illuminance information, environmental sound information, or the like included in the sensor signal S3, and the activity information is generated by the information processing device 1 or any other device based on, for example, position information, acceleration, or the like included in the sensor signal S3.

The training data storage unit 42 stores training data to be used for training the stress estimation model. The training data is data generated for a plurality of sample target persons, and includes a plurality of sets (records) of observation data regarding the sample target persons and the corresponding correct answers of the stress values based on answers of questionnaires by the sample target persons. In the present example embodiment, a PSS (Perceived Stress Scale) value is used as a stress value of a correct answer. The PSS value is calculated from the answer of a PSS questionnaire which can measure the dynamical stress that varies over time.

The learned parameter storage unit 43 stores the parameters trained by the information processing device 1. The parameters stored in the learned parameter storage unit 43 includes the parameters necessary for building (configuring) the stress estimation model. The stress estimation model is a model trained to output a stress estimate value of a target person when a set (i.e., feature vector) of specific kinds of observed feature values of the target person is inputted thereto. Here, the stress estimation model may be any machine learning model (including a statistical model) such as a neural network, a support vector machine, and the like. In addition, as will be described later, the stress estimation model is trained for each class according to the attribute of the target person. In this case, each stress estimation model may have an architecture suitable for each corresponding class. The learned parameter storage unit 43 stores parameter information necessary for building these stress estimation models. For example, when the stress estimation model is a model based on a neural network such as a convolutional neural network, the learned parameter storage unit 43 stores information regarding various parameters such as the layer structure, the neuron structure of each layer, the number of filters and the filter size in each layer, and the weight for each element of each filter.

The configuration of the stress estimation system 100 shown in FIG. 1 is an example, and various changes may be made to the configuration. For example, the input device 2 and the display device 3 may be configured integrally. In this case, the input device 2 and the display device 3 may be configured as a tablet-type terminal that is incorporated into or separate from the information processing device 1. Further, the input device 2 and the sensor 5 may be configured integrally. Further, the information processing device 1 may be configured by a plurality of devices. In this case, the plurality of devices constituting the information processing device 1 performs transmission and reception of information necessary for executing preassigned processing among the plurality of devices. In this case, the information processing device 1 functions as an information processing system.

### (2) Hardware Configuration of Information Processing Device

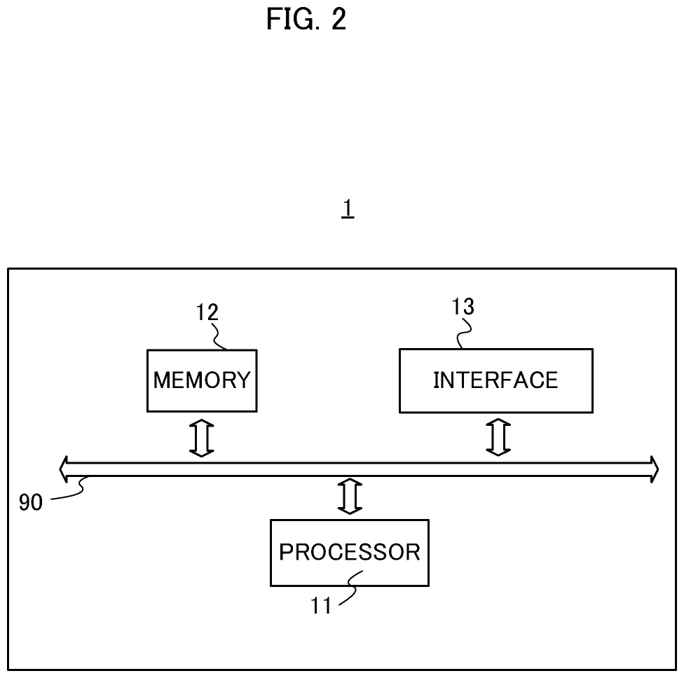

FIG. 2 shows a hardware configuration of the information processing device 1. The information processing device 1 includes a processor 11, a memory 12, and an interface 13 as hardware. The processor 11, memory 12 and interface 13 are connected to one another via a data bus 90.

The processor 11 functions as a controller (arithmetic unit) configured to control the entire information processing unit 1 by executing a program stored in the memory 12. Examples of the processor 11 include a CPU (Central Processing Unit), a GPU (Graphics Processing Unit), and a TPU (Tensor Processing Unit). The processor 11 may be configured by a plurality of processors. The processor 11 is an example of a computer.

The memory 12 comprises a variety of volatile and non-volatile memories, such as a RAM (Random Access Memory), a ROM (Read Only Memory), and a flash memory. Further, a program for executing a process executed by the information processing device 1 is stored in the memory 12. A part of the information stored in the memory 12 may be stored by one or more external storage devices that can communicate with the information processing device 1, or may be stored by a storage medium detachable from the information processing device 1.

The interface 13 is one or more interfaces for electrically connecting the information processing device 1 to other devices. Examples of these interfaces include a wireless interface, such as a network adapter, for transmitting and receiving data to and from other devices wirelessly, and a hardware interface, such as a cable, for connecting to other devices.

The hardware configuration of the information processing device 1 is not limited to the configuration shown in FIG. 2. For example, the information processing device 1 may include at least one of the input device 2 and the display device 3. Further, the information processing device 1 may be connected to or incorporate a sound output device such as a speaker.

### (3) Learning Phase

Next, the process in the learning phase executed by the information processing device 1 will be described. Schematically, the information processing device 1 trains estimation models for respective classes classified by the attribute or the like of a target person. At this time, based on the attribute of the corresponding sample target person, the environmental information corresponding to the observed feature values, the information processing device 1 sorts (divides) the observed feature values included in the training data into clusters (groups) according to the biases in the stress tendency or the biological information. Then, the information processing device 1 selects the observed feature values (also referred to as “stress estimation feature values”) to be used for input to the corresponding stress estimation model, on the basis of a correlation between each cluster of the sorted observed feature values and the corresponding the stress values that are used as correct answers. As described above, the information processing device 1 selects the observed feature values having a high correlation with the stress data as the stress estimation feature values and trains the stress estimation models specialized for respective clusters each having a bias in the stress tendency or the biological information. Thus, the information processing device 1 acquires stress estimation models capable of performing stress estimation with high accuracy for unknown data not used for training.

### (3-1) Function Blocks

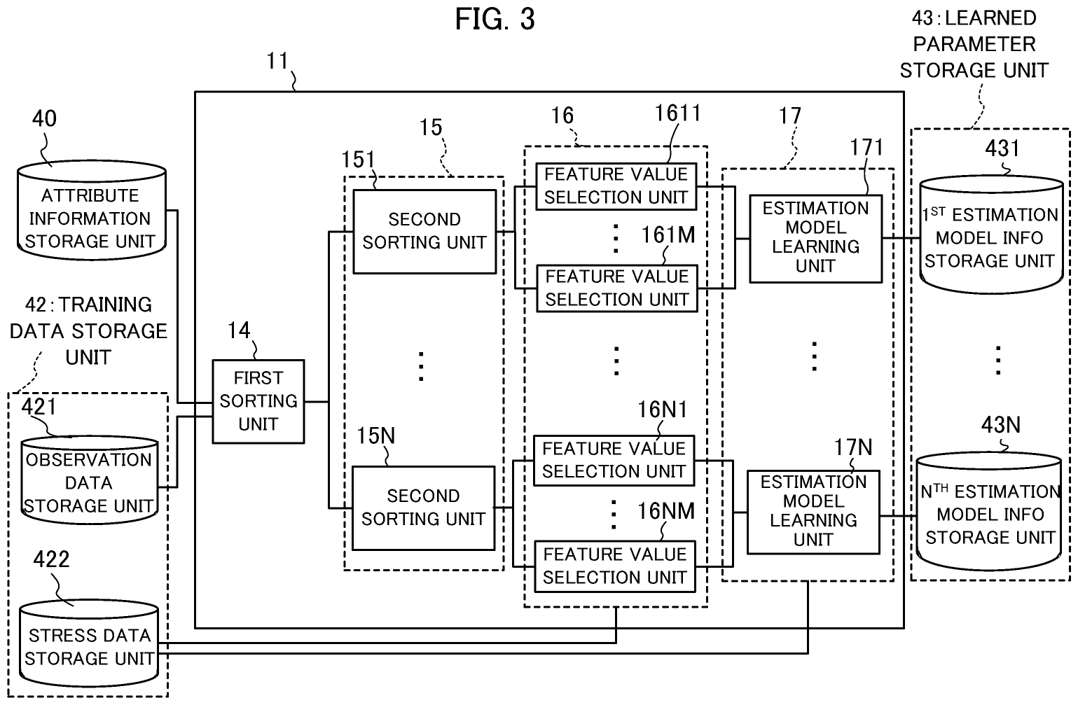

FIG. 3 is an example of functional blocks of the information processing device 1. The processor 11 of the information processing device 1 functionally includes, in the learning phase, a first sorting unit 14, N (N is an integer of 2 or more) second sorting units 15 (151 to 15N), M (M is an integer of 2 or more) feature value selection units 16 (1611 to 16NM), and N estimation model learning units 17 (171 to 17N). In FIG. 3, any blocks to exchange data with each other are connected by a solid line, but the combination of blocks to exchanging data with each other is not limited to the combination shown in FIG. 3. The same applies to the drawings of other functional blocks described below. In addition, the training data storage unit 42 functionally includes an observation data storage unit 421 and a stress data storage unit 422. Furthermore, the learned parameter storage unit 43 functionally includes a first estimation model information storage unit 431 to an N-th estimation model information storage unit 43N for storing parameters of N stress estimation models to be trained, respectively.

The first sorting unit 14 extracts the observed feature values to be used for training from the observation data storage unit 421 and applies first sorting to the extracted observed feature values, wherein the first sorting divides the extracted observed feature values into N groups based on the corresponding attribute information or the environmental information (for example, date and time information). Thus, N clusters, which are biased in stress and biological features, of the observed feature values are generated. The first sorting unit 14 extracts the attribute information from the attribute information storage unit 40 and extracts the environmental information from the observation data storage unit 421.

Here, the sorting based on attribute information is, for example, a sorting based on personality, gender, job type, race, age, height, weight, muscle mass, lifestyle habit, exercise habit, or a combination thereof. In addition, the sorting based on the environmental information is the sorting based on the season at the time of examination, the sorting based on the time (time slot), the sorting based on the place (e.g., outdoor or indoor), or the sorting by the combination of them. Then, the first sorting unit 14 supplies the clusters of the observed feature values sorted based on the first sorting to the respective second sorting units 15 (151 to 15N) each of which is previously associated with each class of the clusters.

The first sorting is not limited to the mode of exclusively sorting one observed feature value to any one of the clusters, and it may be a mode of sorting one observed feature value into two or more clusters redundantly. For example, when the first sorting is applied based on the observed season, there may be clusters with an overlapping period with each other such as “a cluster corresponding to the period from April to June” and “a cluster corresponding to the period from June to September”. This is also true for the second sorting to be described later.

In some embodiments, the first sorting unit 14 performs processing for generating pseudo data obtained by augmenting the training data. The generation of pseudo-data is described in detail in the section “(3-3) Augmentation of Training Data”.

The second sorting unit 15 (151 to 15N) applies the second sorting to the observed feature value for each cluster supplied from the first sorting unit 14, wherein the observed feature values for each cluster are sorted by the second sorting into M clusters (sub-clusters) based on the activity state of the target person at the time of observation or the target to be observed in acquiring the observed feature values. Thereby, the second sorting unit 15 further sorts the observed feature values to be handled differently in the stress estimation. Then, each of the second sorting units 151 to 15N supplies the M sub-clusters of the observed feature values sorted based on the second sorting to the corresponding feature value selection unit 16 (1611 to 16NM).

The term “target to be observed” herein indicates raw data to be observed used in calculating the observation feature values and examples thereof include various biological features such as perspiration, acceleration, skin temperature, and pulse wave. Thus, the “sorting based on the target to be observed” is to sort, for example, the observed feature values based on biological features into “observed feature values relating to perspiration”, “observed feature values relating to acceleration”, observed feature values relating to skin temperature”, and “observed feature values relating to pulse wave”. Further, the term “sorting based on activity state” herein indicates, for example, sorting according to the level (e.g., stationary state, walking state, or running state) of exercise intensity at the observation of the target person. The information indicating the target to be observed and information indicating the activity state corresponding to each observed feature value are stored in association with the each observed feature value in the observation data storage unit 421, for example.

Each feature value selection unit 16 (1611 to 16NM) selects the stress estimation feature values from the N-by-M sub-clusters of the observed feature values sorted by the first sorting and the second sorting, based on the correlations with the stress data to be the correct answer, wherein the stress estimation feature values are observed feature values to be inputted into a stress estimation model. It is herein assumed that each feature value selection unit 16 selects “R” (R is an integer of 0 or more) types of observed feature values as the stress estimation feature values. Details of the processing in the feature value selection units 16 will be described later. It is noted that the number of feature value selection units 16 may be an appropriate number for ach cluster generated by the first sorting, instead of M uniformly for each cluster generated by the first sorting. In the same way, the value of R may be different among the feature value selection units 16.

Each estimation model learning unit 17 (171 to 17N) trains a stress estimation model prepared per cluster sorted by the first sorting unit 14, based on the stress estimation feature values selected by the corresponding feature value selection unit 16 and the stress data referred to from the stress data storing unit 422. In this case, each estimation model learning unit 17 acquires a plurality of sets of the input data, to the corresponding stress estimation model, that is the M-by-R stress estimation feature values supplied from the M feature value selection units 16 and the corresponding correct answer data that is the corresponding stress data referred to from the stress data storage unit 422. Then, each estimation model learning unit 17 trains the corresponding stress estimation model on the basis of a plurality of sets of the above-described input data and the corresponding correct answer data.

In training the corresponding stress estimation model, for example, each estimation model learning unit 17 extracts a set of the input data and the correct answer data described above in order, and updates the parameters of the stress estimation model. In this case, the parameters of the stress estimation model are determined so that the error (loss) between the estimated result outputted by the stress estimation model when input data is inputted thereto and the stress value (PSS value in this case) that is corresponding correct answer data is minimized.

The algorithm for determining parameters to minimize the loss may be any learning algorithm used in machine learning, such as the gradient descent method and error back propagation method. The estimation model learning units 17 store the parameters of the trained stress estimation models in the first estimation model information storage unit 431 to the Nth estimation model information storage unit 43N, respectively.

Each component of the first sorting unit 14, the second sorting units 15, the feature value selection units 16, and the estimation model learning units 17 described in FIG. 3 can be realized by the processor 11 executing a program, for example. Additionally, the necessary programs may be recorded on any non-volatile storage medium and installed as necessary to realize each component. It should be noted that at least a portion of each of these components may be implemented by any combination of hardware, firmware, and software, without being limited to being implemented by software based on a program. At least some of these components may also be implemented using user programmable integrated circuit such as, for example, a FPGA (Field-Programmable Gate Array) and a microcontroller. In this case, the integrated circuit may be used to realize a program functioning as each of the above components. Further, at least a part of the components may be configured by ASSP (Application Specific Standard Produce), ASIC (Application Specific Integrated Circuit) or a quantum processor (quantum computer control chip). Thus, each of the above-described components may be realized by various hardware. Furthermore, each of these components may be implemented by cooperation of a plurality of computers, for example, using cloud computing technology. The above is true for other example embodiments described later.

### (3-2) Details of Feature Value Selection Unit

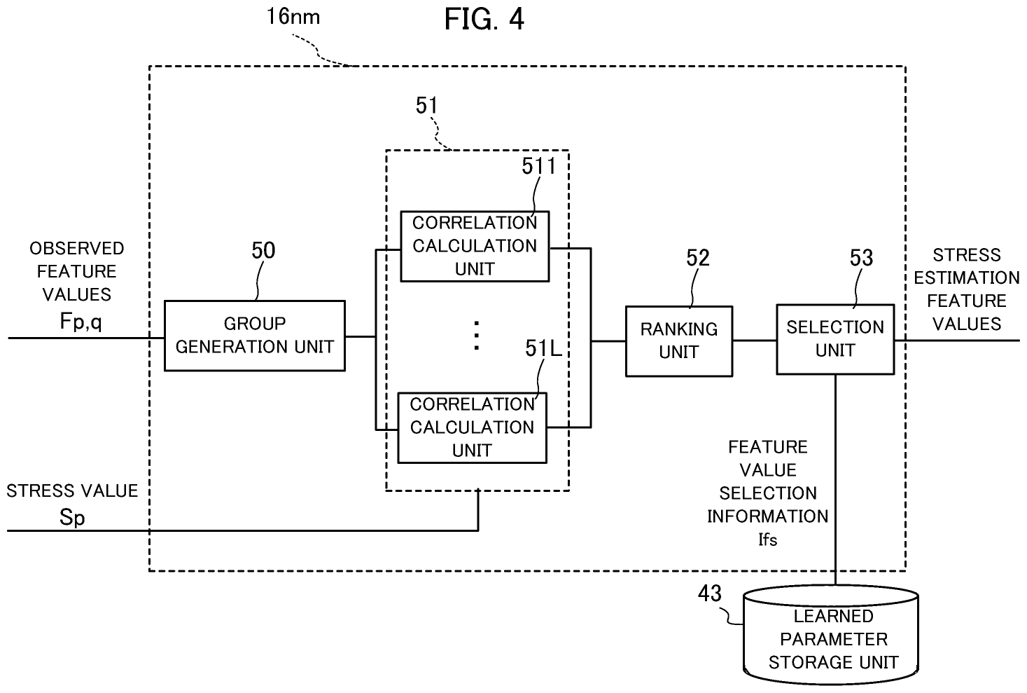

Next, a detailed description will be given of the process executed by the feature value selection units 16 (1611 to 16NM). FIG. 4 is an exemplary functional block diagram regarding a certain feature value selection unit 16nm (“n” and “m” are integers satisfying 1≤n≤N, 1≤m≤M). The feature value selection unit 16nm functionally includes a group generation unit 50, a correlation calculation unit 51, a ranking unit 52, and a selection unit 53.

The feature value selection unit 16nm acquires the observed feature values “F_{p, q}” from the second sorting unit 15n and acquires the stress value (PSS value) “Sₚ” that is the correct answer corresponding to the observed feature value F_{p, q} from the stress data storage unit 422. Here, “p” indicates the index (1≤p≤P, P is an integer of 2 or more) of the sample target person, and “q” indicates the index (1≤q≤Q, Q is an integer satisfying “Q≥R”) of the type of the observed feature value. It is noted that there are generally a large number (e.g., several tens of thousands) of types of observed feature values. For example, in the case of the feature value relating to the amount of perspiration, examples of the types include the maximum value of the amount of perspiration, the minimum value, the median value, the average value, and any other various indices relating to the amount of perspiration.

The group generation unit 50 repeats, L times (L is an integer of 1 or more), random extraction of a predetermined number of the observed feature values F_{p, q}, and generates L groups of the observed feature values F_{p, q}, wherein each group includes the predetermined number of the extracted observed feature values F_{p, q}. In this case, for example, when there are a hundred sample target persons, the group generation unit 50 repeats, L times, the random extraction of the observed feature values F_{p, q} for fifty sample target persons and uses the observed feature values F_{p, q} extracted at each extraction as a group. Then, the group generation unit 50 supplies groups of the observed features F_{p, q} to the correlation calculation units 511 to 51L, respectively.

The correlation calculation units 51(511 to 51L) calculates a correlation (correlation coefficient) between the observed feature values F_{p,q} and the stress values Sₚ for each type q of the observed feature values F_{p, q}, based on the corresponding group of the observed feature values F_{p,q} supplied from the group generation unit 50. Examples of the correlation coefficient include Spearman's rank correlation coefficient, Pearson's product-moment correlation coefficient, Kendol's rank correlation coefficient, and a combination (such as an average value) of these correlation coefficients. In other words, the correlation calculation unit 51 calculates the correlation between the observed feature values F_{p,q} and the stress values Sₚ with respect to each group generated by the group generation unit 50 and each type q of the observed feature valued F_{p, q}.

The ranking unit 52 ranks each type q of the observation feature values F_{p, q} based on the calculation results generated by the L correlation calculation units 511 to 51L. In this instance, the ranking unit 52 calculates a score (also referred to as “correlation score”) for each type q of the observed feature values F_{p, q}, based on the calculation results generated by the L correlation calculation units 511 to 51L. Then, the ranking unit 52 determines that the higher the correlation score is, the higher the ranking becomes. In this case, the ranking unit 52 calculates the correlation score based on the statistical value such as the average of the correlations among the groups and the degree of sign inversion to be described later. The method of calculating the correlation score will be described later.

The selection unit 53 selects the observed feature values F_{p, q} corresponding to the top R types in the ranking generated by the ranking unit 52 as the stress estimation feature values. In this instance, the selection unit 53 stores information (also referred to as “feature value selection information Ifs”) indicating the types of the observed feature values selected as the stress estimation feature values in the learned parameter storage unit 43. As will be described later, the feature value selection information Ifs is used in the process of selecting the stress estimation feature values to be inputted to the stress estimation model from the observed feature values in the estimation phase.

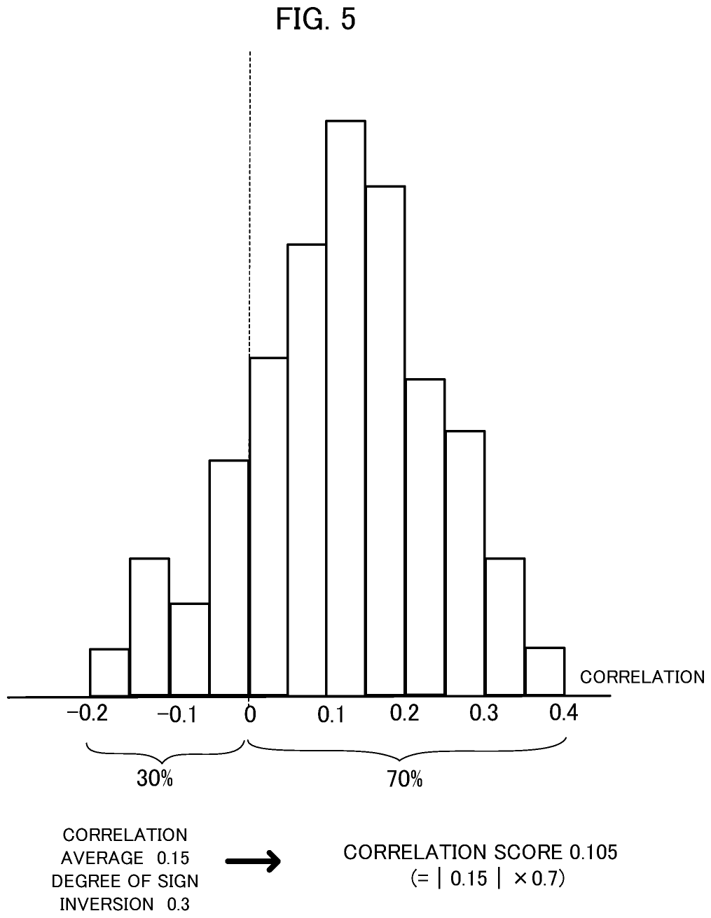

Here, a specific example of a method of calculating the correlation score by the ranking unit 52 will be described. FIG. 5 shows a histogram of correlations regarding a target type q that is a target for calculating the correlation score aggregated based on the calculation results generated by the correlation calculation units 511 to 51L. Although the histogram is shown here for convenience of explanation, the generation of the histogram is not an essential process in the calculation of the correlation score.

In this case, first, the correlation calculation unit 51 calculates the average value (0.15 in this case) of the correlations (correlation coefficients) calculated by the correlation calculation units 511 to 51L for the target type q, based on the calculation results outputted by the correlation calculation units 511 to 51L. In addition, the correlation calculation unit 51 calculates the ratio of the minority sign group as the degree of sign inversion, in the case where the signs of the calculated correlations are sorted into positive sign group and negative sign group. In the example shown in FIG. 5, since the positive sign group is the majority, the correlation calculation unit 51 recognizes the ratio (0.3) of the negative sign group as the degree of sign inversion. The degree of sign inversion ranges from 0 to 0.5. Then, for example, the correlation calculation unit 51 determines the correlation score for the target type q to be a value obtained by multiplying the absolute value of the average value of the correlations by a weight that is a value (i.e., which ranges from 0.5 to 1) obtained by subtracting the degree of sign inversion from 1, as follows.

Correlation Score=|Average of Correlations|×(1−Degree of Sign Inversion)

In the example shown in FIG. 5, the correlation score of the target type q is 0.105 (=|0.15|×0.7).

The calculation method of the correlation score is not limited to the above-described equation, and an arbitrary equation or a look-up table, which indicates the correlation score to have a positive correlation with the average value of the correlations while having a negative correlation with the degree of sign inversion, may be used.

With a functional configuration as shown in FIG. 4, the feature value selection unit 16nm can suitably select the stress estimation feature values that are the observed feature values stably correlated with the stress value regardless of the individual difference.

### (3-3) Augmentation of Training Data

Next, the method of augmentation (Data Augmentation) of the training data will be described. Generally, samples with low stress values and samples with high stress values tend to be insufficient. On the other hand, the chronic stress does not change abruptly by the time course. In view of the above, the first sorting unit 14 generates stress values that are correct answers by interpolation.

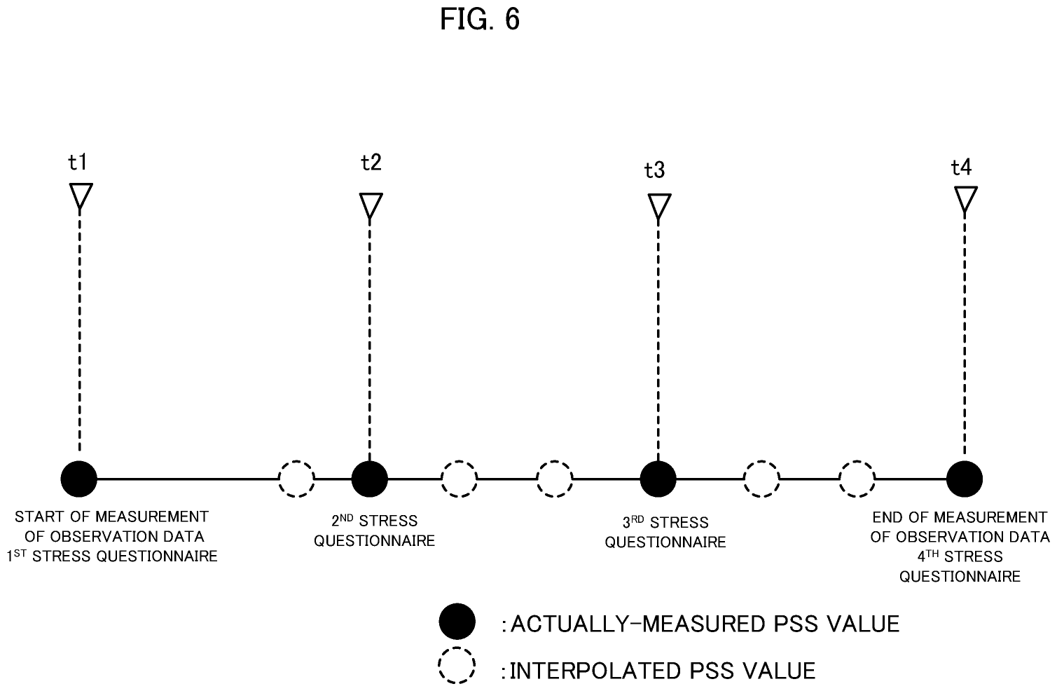

FIG. 6 is a diagram showing the timing of conducting a stress questionnaire for measuring the PSS value during the measurement period of the observation data of a certain sample target person. In the example shown in FIG. 6, measurement of the observation data of the sample target person starts at the date and time “t1” and the first stress questionnaire is conducted. At the date and time “t2” to “t4”, the second to the fourth stress questionnaires are also conducted, respectively. such a stress questionnaire is conducted, for example, every month. Thereby, a PSS value (measured PSS value) of the sample target person of interest is measured by each stress questionnaire. It is noted that each actually-measured PSS value measured at the date and time t1 to t4 actually corresponds to the stress value in the target period in the corresponding questionnaire. For example, when the questionnaires are conducted at intervals of one month, the PSS value corresponds to the stress value for one month.

In this case, in the interval between measurements of the actually-measured PSS values, the first sorting unit 14 generates, at regular intervals, pseudo-data that is a PSS value (interpolated PSS value) interpolated using actually-measured PSS values (e.g., by linear interpolation). Here, the first sorting unit 14 generates two interpolated PSS values in the period from the date and time t2 to the date and time t3 and in the period from the date and time t3 to the date and time t4. Then, the first sorting unit 14 uses these interpolated PSS values as correct answers of the stress values for predetermined time periods according to the intervals of conducting the questionnaires. Here, the observation data are continuously measured regardless of the interval of conducting the questionnaire, etc., and the observation data corresponding to these interpolated PSS values is generated during the time period from the time t1 to the time t4. As for the period from the time t1 to the time t2, since there is no observation data corresponding to the interpolated PSS value at the interpolation point close to the time t1, only the interpolation PSS value at the interpolation point close to the time t2 is generated.

Thus, the first sorting unit 14 generates the interpolated PSS values in view of the fact that the chronic stress does not change rapidly. Thereby, it is possible to substantially increase the amount of training data and suitably secure training data necessary for training the stress estimation model.

### (3-4) Processing Flow

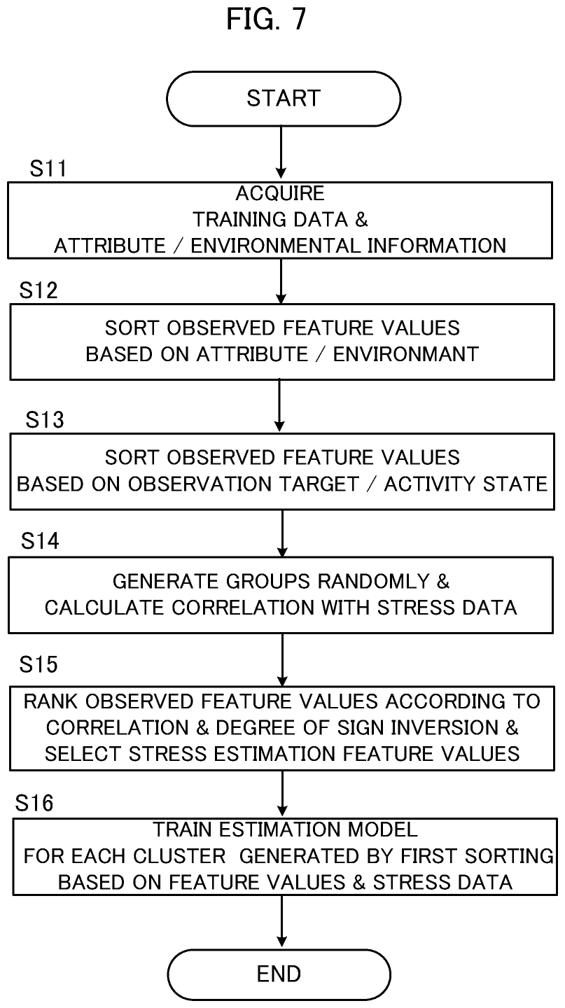

FIG. 7 is an example of a flowchart illustrating a procedure of a learning process that is executed by the information processing device 1 in a learning phase according to the first example embodiment.

First, the information processing device 1 acquires the training data to be used for training stress estimation models and the attribution information and/or the environmental information regarding the sample target person corresponding to the training data (step S11). In this case, for example, the information processing device 1 acquires training data and environmental information from the training data storage unit 42 and acquires attribute information from the attribute information storage unit 40.

Then, the first sorting unit 14 of the information processing device 1 performs the first sorting of sorting the observed feature values of the training data based on at least either the attribute of the sample target person indicated by the attribute information or the environment (e.g., season or the like) at the time of measurement indicated by the environmental information such as the date and time information (step S12). Thereby, the first sorting unit 14 divides the observed feature values into N clusters.

Next, the second sorting unit 15 of the information processing device 1 sorts the observed feature values based on the second sorting according to the observation target to obtain the observed feature values and the activity state of the corresponding sample target person at the time of observation (step S13). In this case, for example, the second sorting unit 15 generates M sub-clusters of the observed feature values for each of N clusters of the observed feature values based on the second sorting according to the type of the observed biological feature, the exercise intensity of the sample target person, or the like.

Next, the feature value selection unit 16 of the information processing device 1 generates, for each sub-cluster, groups by random, and calculates, among each generated group, a correlation with the stress data included in the training data for each type of the observed feature values (step S14). Furthermore, the feature value selection unit 16 ranks the types of the observed feature values according to the correlations and the degree of sign inversion among each sub-cluster, and selects top R of the types of the observed feature values in the ranking as the stress estimation feature values (step S15).

Then, the estimation model learning unit 17 of the information processing device 1 trains the stress estimation models corresponding to respective clusters sorted by the first sorting, based on the stress estimation feature values and the stress data indicating the corresponding correct stress value included in the training data (step S16). The information processing device 1 outputs the feature value selection information Ifs regarding the stress estimation feature values selected at step S15 and the parameters of the stress estimation models trained at step S16 as the learning result. Specifically, the information processing device 1 stores the feature value selection information Ifs and the parameters of the stress estimation models in the learned parameter storage unit 43. Thus, the information processing device 1 can store necessary information in the storage device 4 in the estimation phase.

### (4) Estimation Phase

Next, the process in the estimation phase executed by the information processing device 1 will be described. The information processing device 1 estimates the stress value of the estimation target person based on the stress estimation model trained in the learning phase.

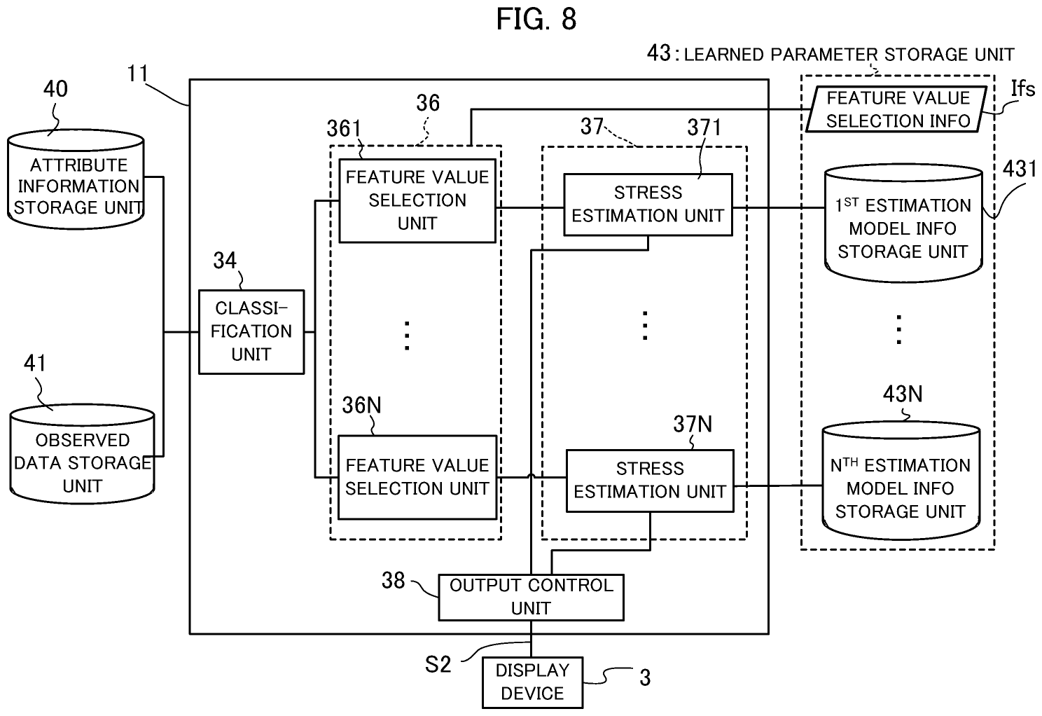

FIG. 8 is an example of functional blocks in the estimation phase of the information processing device 1. The processor 11 of the information processing device 1 functionally includes a classification unit 34, N feature value selection units 36 (361 to 36N), and N stress estimation units 37 (371 to 37N) in the estimation phase. The first estimation model information storage unit 431 to the N-th estimation model information storage unit 43N included in the learned parameter storage unit 43 store the parameters of the N stress estimation models that have already been trained in the learning phase.

The classification unit 34 extracts the observed feature values of the estimation target person from the observation data storage unit 41 and classifies the extracted observed feature values according to the stress estimation models (the first estimation model to the Nth estimation model) to be used, based on at least one of the corresponding attribute information and/or the environmental information. The classification method of the observed feature values by the classification unit 34 is the same as the cluster generation method used in the first sorting by the first sorting unit 14. Therefore, the observed feature values of the estimation target person corresponding to the attribute information and/or the environmental information which falls under the same class as the cluster supplied from the first sorting unit 14 to the second sorting unit 15n (n is any integer from 1 to N) is supplied to the feature value selection unit 36n. That is, the second sorting unit 15n and the feature value selection unit 36n deal with the observed feature values which fall under the same class.

The classification unit 34 does not necessarily classify each observed feature value of the estimation target person so as to be assigned to any one stress estimation model, but may classify each observed feature value so as to be assigned to two or more stress estimation models redundantly.

The feature value selection unit 36 (361 to 36N) selects the stress estimation feature values from the observed feature values supplied from the classification unit 34, based on the feature value selection information Ifs stored in the learned parameter storage unit 43. In this instance, the feature value selection unit 36n (where n is any integer from 1 to N) extracts, as the stress estimation feature values, the observed feature values which fall under the same types as the types of the stress estimation feature values indicated by the feature value selection information Ifs generated by the feature value selection units 16n1 to 16nM from the observed feature values supplied by the classification unit 34. Then, the feature value selection unit 36n supplies the extracted stress estimation feature values to the corresponding stress estimation unit 37n.

The stress estimation units 37 (371 to 37N) estimate the stress of the estimation target person based on the stress estimation models. In this case, the stress estimation unit 37n (where n is any integer from 1 to N) builds the corresponding n-th estimation model by referring to the corresponding n-th estimation model information storage unit 43n. The stress estimation unit 37n acquires the stress value of the estimation target person outputted by the n-th estimation model by inputting the stress estimation features supplied from the corresponding feature value selection unit 36n to the built n-th estimation model. The stress estimation unit 37n supplies the stress value outputted by the n-th estimation model to the output control unit 38.

The output control unit 38 outputs information based on the estimated stress value (stress estimate value) of the estimation target person. For example, the output control unit 38 generates a display signal S2 for displaying information regarding the stress estimate value, and supplies the display signal S2 to the display device 3, thereby causing the display device 3 to display information regarding the stress estimate value. Here, if the output control unit 38 obtains the stress values from plural stress estimation units 37, the output control unit 38 calculates the average value, the median value, the maximum value, or any other statistical value (representative value) of the obtained plural stress values, as the stress estimate value of the estimation target person, and displays it on the display device 3.

Instead of or in addition to performing control for displaying the stress estimate value itself, the output control unit 38 may perform control for displaying information regarding the level of the stress that is determined based on the comparison between the stress estimate value and a predetermined threshold value, and/or information regarding advice in accordance with the level. The viewer of the display device 3 in this case, for example, may be the estimated target person, or may be a person who manages or supervises the estimated target person. The output control unit 38 may perform audio output of information regarding the stress estimate value by a sound output device (not shown).

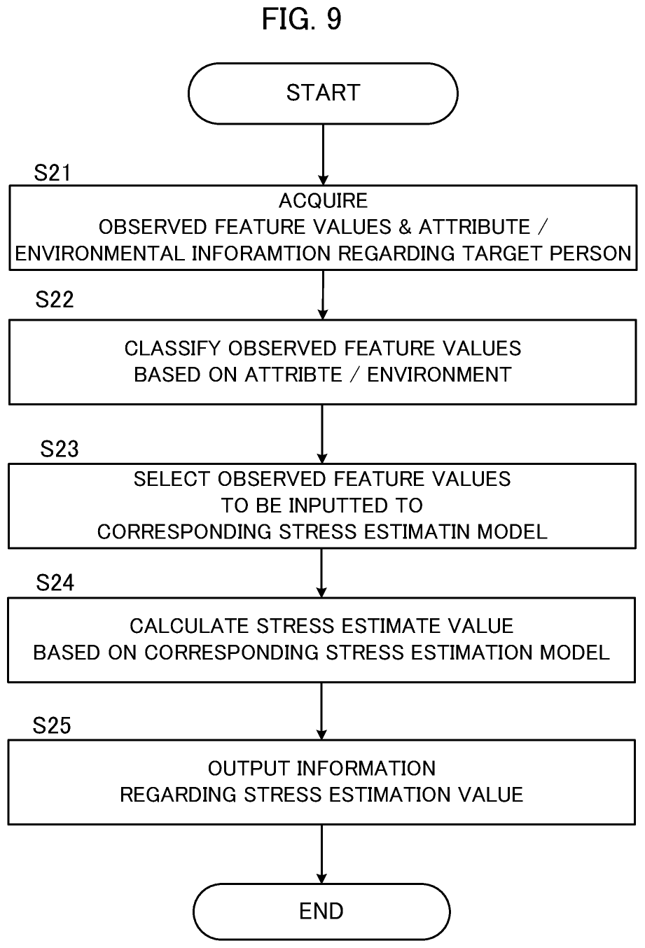

FIG. 9 is an example of a flowchart illustrating a procedure of the stress estimation process that is executed by the information processing device 1 in the estimation phase. The timing at which the stress estimation process is performed may be a timing requested by the user based on the input signal S1 or may be a predetermined timing.

First, the information processing device 1 acquires observed feature values of an estimation target person and the attribute information or/and the environmental information regarding the estimation target person (step S21). In this case, for example, the information processing device 1 acquires the observed feature values and the environmental information from the observation data storage unit 41 and acquires the attribute information from the attribute information storage unit 40.

Next, the classification unit 34 of the information processing device 1 classifies the observed feature values based on at least one of the attribute of the estimation target person indicated by the attribute information, or the environment (e.g., the season) at the time of measurement indicated by the environmental information such as the date and time information (step S22). Thus, the classification unit 34 assigns the observed feature values to at least one of the first estimation model to the N-th estimation model. The observed features values may be redundantly assigned to multiple stress estimation models.

Then, the feature value selection unit 36 of the information processing device 1 selects the observed feature values to be inputted into the corresponding stress estimation model (step S23). In this case, when the feature value selection unit 36 receives the observed feature values from the classification unit 34, the feature value selection unit 36 refers to the corresponding feature value selection information Ifs and selects the stress estimation feature values that are observed feature values to be inputted to the corresponding stress estimation model.

The stress estimation unit 37 of the information processing device 1 calculates the stress estimate value based on the corresponding stress estimation model (step S24). In this case, when the stress estimation unit 37 receives the stress estimation feature values from the feature value selection unit 36, the stress estimation unit 37 builds the corresponding stress estimation model by referring to the learned parameter storage unit 43 and calculates the stress estimate value by inputting the stress estimation feature values into the built stress estimation model. If plural stress estimation models are used, the information processing device 1 determines a stress estimate obtained by integrating the estimation results outputted by these stress estimation models. Then, the output control unit 38 of the information processing device 1 outputs the information regarding the stress estimate value (step S25).

### (5) Modification

The stress estimation model may be provided for each sub-cluster formed by the first sorting and the second sorting instead of being provided for each cluster formed by the first sorting.

In this case, in the learning phase, the information processing device 1 provides N-by-M stress estimation models corresponding to the N-by-M feature value selection units 1611 to 16NM, respectively. Then, the information processing device 1 trains each stress estimation model by using the stress estimation feature values outputted by the corresponding feature value selection unit 16 as input data and using the stress value indicated by the corresponding stress data as correct answer data. In the estimation phase, in the same way as the feature value selection unit 16 in the learning phase, there are N-by-M feature value selection units 36, and each stress estimation unit 37 inputs the stress estimation feature values outputted by M corresponding feature value selection units 36 into M corresponding stress estimation models, respectively. Thus, the stress estimation unit 37 acquires the M stress values and determines a stress estimate obtained by integrating the M stress values.

Thus, even in the present modification, the information processing device 1 can accurately estimate the stress state of the estimation target person from the observed feature values that are not used for learning based on the learned stress estimation model for each cluster having a bias in the stress tendency.

It is noted that the stress estimated by the information processing device 1 is not limited to the chronic stress, but may be the short-term stress that varies in a relatively short period (several minutes to about one day).

### Second Example Embodiment

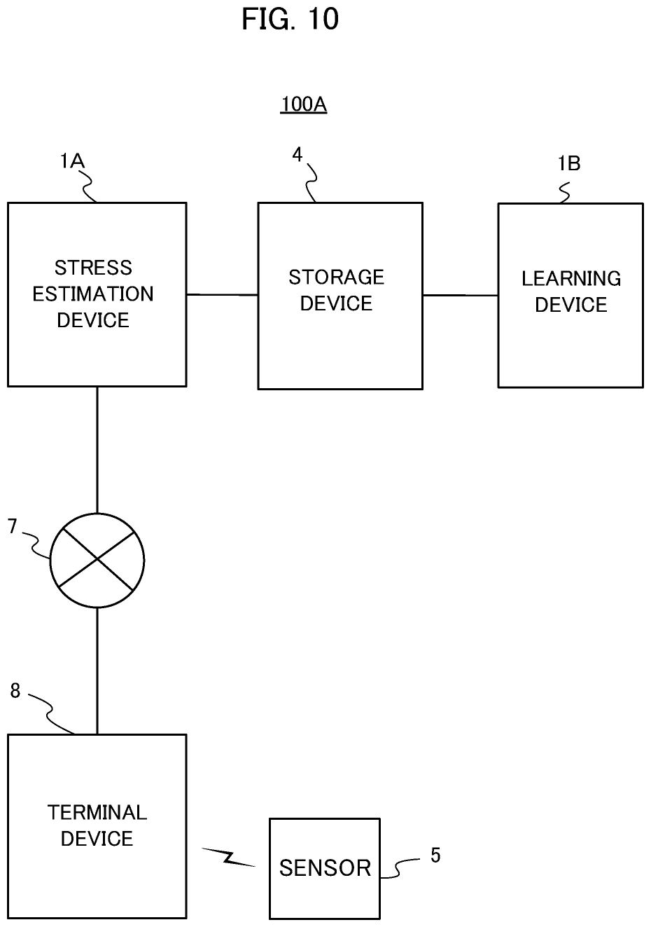

FIG. 10 shows a schematic configuration of a stress estimation system 100A according to the second example embodiment. The stress estimation system 100A according to the second example embodiment includes a stress estimation device 1A that performs process in the estimation phase that was performed by the information processing device 1 in the first example embodiment, a learning device 1B that performs process in the learning phase that was performed by the information processing device 1 in the first example embodiment, and a terminal device 8 and a sensor 5 that are used by the estimation target person. Hereinafter, the same components as those in the first example embodiment are appropriately denoted by the same reference numerals, and a description thereof will be omitted.

As shown in FIG. 10, the stress estimation system 100A mainly includes a stress estimation device 1A that functions as a server, a storage device 4, and a terminal device 8 that functions as a client. The stress estimation device 1A and the terminal device 8 perform data communication with each other via the network 7.

The learning device 1B has a hardware configuration identical to the hardware configuration of the information processing device 1 shown in FIG. 2, and the processor 11 of the learning device 1B has functional blocks shown in FIG. 3. The learning device 1B performs a learning process such as parameter updating of the stress estimation models and generates the feature value selection information Ifs on the basis of information stored in the storage device 4.

The terminal device 8 is a terminal used by a user that is an estimation target person, and is equipped with an input function, a display function, and a communication function, and thereby functions as the input device 2, the display device 3, and the like shown in FIG. 1. The terminal device 8 may be, for example, a personal computer, a tablet-type terminal such as a smartphone, a PDA (Personal Digital Assistant), or the like. The terminal device 8 is electrically connected to the sensor 5 such as the wearable sensor worn by the user, and transmits the biological signal or the like (that is, information corresponding to the sensor signal S3 in FIG. 1) of the estimation target person outputted by the sensor 5 to the stress estimation device 1A through the network 7. Further, the terminal device 8 receives the user input or the like relating to the answer of the questionnaire, and transmits the information (information corresponding to the input signal S1 in FIG. 1) generated by the user input to the stress estimation device 1A.

The stress estimation device 1A has the same hardware configuration as the hardware configuration of the information processing device 1 shown in FIG. 2, and the processor 11 of the stress estimation device 1A has the functional blocks shown in FIG. 8. The stress estimation device 1A receives information corresponding to the input signal S1 and the sensor signal S3 in FIG. 1 from the terminal device 8 via the network 7, and stores the received information in the storage device 4. Then, the stress estimation device 1A refers to the parameters of the stress estimation model(s) and the feature value selection Ifs learned by the learning device 1B and executes a stress estimation process regarding the estimation target person. The stress estimation device 1A transmits an output signal for outputting the stress estimation result to the terminal device 8 through the network 7 based on the display request from the terminal device 8.

Thus, in the stress estimation system 100A in the second example embodiment, the learning phase and the estimation phase are conducted by separate devices, respectively and it is possible to train the stress estimation models and stress estimation using the stress estimation models in the same manner as in the first example embodiment. Further, in the second example embodiment, the stress estimation device 1A estimates the stress state of the estimation target person based on the biological signal or the like of the estimation target person received from the terminal used by the estimation target person, and can suitably present the estimation result to the estimation target person on the terminal.

### Third Example Embodiment

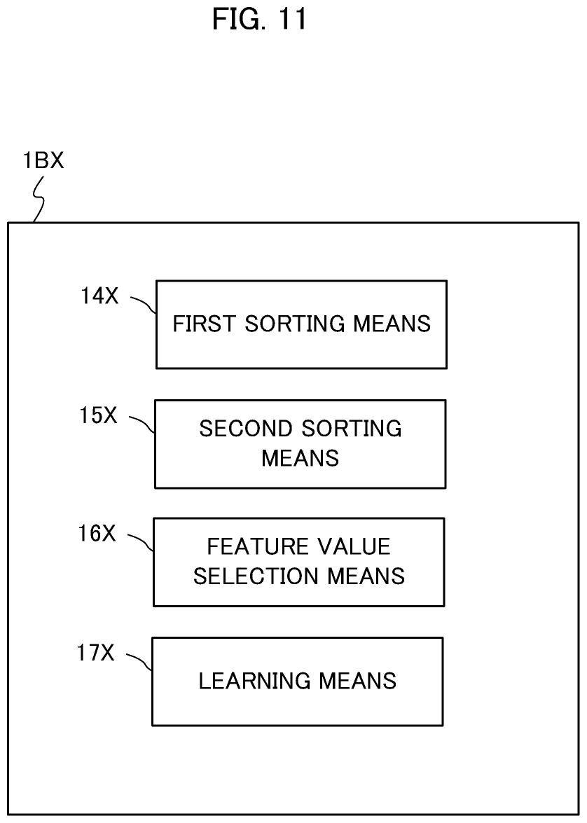

FIG. 11 is a block diagram of a learning device 1BX according to a third example embodiment. The information processing device 1X mainly includes a first sorting means 14X, a second sorting means 15X, a feature value selection means 16X, and a learning means 17X. The learning device 1BX may be configured by a plurality of devices.

The first sorting means 14X is configured to perform a first sorting for sorting observation feature values of a target person based on at least one of an attribute and/or environment of the target person. Examples of the first sorting means 14X include the first sorting unit 14 in the first example embodiment (including the modification, hereinafter the same) or the second example embodiment. The second sorting means 15X is configured to perform a second sorting for sorting the observed feature values based on at least one of an observation target of the observed feature values and/or an activity state of the target person. Examples of the second sorting means 15X include the second sorting unit 15 in the first example embodiment or the second example embodiment.

The feature value selection means 16X is configured to select stress estimation feature values, which are feature values to be used for stress estimation, from the observed feature values sorted based on the first sorting and the second sorting. Examples of the feature value selection means 16X include the feature value selection unit 16 in the first example embodiment or the second example embodiment. The learning means 17X is configured to train a stress estimation model based on the stress estimation feature values and stress values that are correct answers corresponding to the stress estimation feature values, at least for each of clusters into which the observed feature values are sorted by the first sorting. Examples of the learning means 17X include the estimation model learning unit 17 according to the first example embodiment or the second example embodiment.

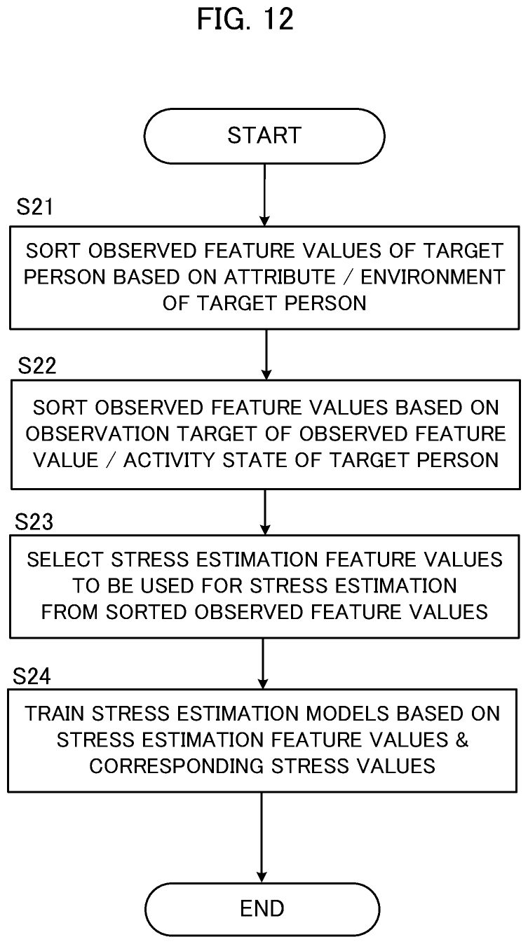

FIG. 12 is an exemplary flowchart that is executed by the learning device 1BX in the third example embodiment. First, the first sorting means 14X performs a first sorting for sorting observation feature values of a target person based on at least one of an attribute and/or environment of the target person (step S31). Besides, the second sorting means 15X performs a second sorting for sorting the observed feature values based on at least one of an observation target of the observed feature values and/or an activity state of the target person (step S32). Furthermore, the feature value selection means 16X selects stress estimation feature values, which are feature values to be used for stress estimation, from the observed feature values sorted based on the first sorting and the second sorting (step S33). Then, the learning means 17X trains a stress estimation model based on the stress estimation feature values and stress values that are correct answers corresponding to the stress estimation feature values, at least for each of clusters into which the observed feature values are sorted by the first sorting (step S34).

According to the third example embodiment, the learning device 1BX can learn the stress estimation model for each cluster having a bias in the stress tendency and train the stress estimation model capable of performing the stress estimation with high accuracy.

In the example embodiments described above, the program is stored by any type of a non-transitory computer-readable medium (non-transitory computer readable medium) and can be supplied to a control unit or the like that is a computer. The non-transitory computer-readable medium include any type of a tangible storage medium. Examples of the non-transitory computer readable medium include a magnetic storage medium (e.g., a flexible disk, a magnetic tape, a hard disk drive), a magnetic-optical storage medium (e.g., a magnetic optical disk), CD-ROM (Read Only Memory), CD-R, CD-R/W, a solid-state memory (e.g., a mask ROM, a PROM (Programmable ROM), an EPROM (Erasable PROM), a flash ROM, a RAM (Random Access Memory)). The program may also be provided to the computer by any type of a transitory computer readable medium. Examples of the transitory computer readable medium include an electrical signal, an optical signal, and an electromagnetic wave. The transitory computer readable medium can provide the program to the computer through a wired channel such as wires and optical fibers or a wireless channel.

The whole or a part of the example embodiments (including modifications, the same shall apply hereinafter) described above can be described as, but not limited to, the following Supplementary Notes.

### [Supplementary Note 1]

A learning device comprising:
a first sorting means configured to perform a first sorting for sorting observation feature values of a target person based on at least one of an attribute and/or environment of the target person;
a second sorting means configured to perform a second sorting for sorting the observed feature values based on at least one of an observation target of the observed feature values and/or an activity state of the target person;
a feature value selection means configured to select stress estimation feature values, which are feature values to be used for stress estimation, from the observed feature values sorted based on the first sorting and the second sorting; and
a learning means configured to train a stress estimation model based on the stress estimation feature values and stress values that are correct answer corresponding to the stress estimation feature values, at least for each of clusters into which the observed feature values are sorted by the first sorting.

### [Supplementary Note 2]

The learning device according to Supplementary Note 1,
wherein the feature value selection means is configured to select the stress estimation feature values, based on a correlation between
   the observed feature values sorted based on the first sorting and the second sorting and
   the stress values.

### [Supplementary Note 3]

The learning device according to Supplementary Note 2,
wherein the feature value selection means is configured to
   generate plural groups by random extraction from the observed feature values sorted based on the first sorting and the second sorting, and
   select the stress estimation feature values based on an aggregated result, for the plural groups, of the correlation calculated per group.

### [Supplementary Note 4]

The learning device according to Supplementary Note 3,
wherein the feature value selection means is configured to calculate, as the aggregation result, the statistical value of the correlations for the plural groups and a ratio of positive/negative signs of the correlations for the plural groups.

### [Supplementary Note 5]

The learning device according to Supplementary Note 1,
wherein the learning means is configured to train the stress estimation model for each of clusters into which the observed feature values are sorted by the first sorting and the second sorting.

### [Supplementary Note 6]

The learning device according to any one of Supplementary Notes 1 to 5,
wherein the learning means is configured to output, as a learning result,
   the feature value selection information that is information regarding the stress estimation feature values selected by the feature value selection means and
   the parameters of the stress estimation model trained by the learning means.

### [Supplementary Note 7]

The learning device according to any one of Supplementary Notes 1 to 6,
wherein the first sorting means is configured to generate pseudo data, which indicates a stress value at a time when the stress values are not measured, by interpolation of the stress values.

### [Supplementary Note 8]

The learning device according to any one of Supplementary Notes 1 to 7,
wherein the first sorting means is configured to perform the first sorting so that a part of the observed feature values redundantly falls under two or more groups.

### [Supplementary Note 9]

A stress estimation device comprising:
a classification means configured to classify observed feature values of an estimation target person subject to stress estimation, based on at least one of an attribute and/or an environment of the estimation target person;
a feature value selection means configured to select stress estimation feature values, which are used for stress estimation, from the observed feature values, based on the classification; and
a stress estimation means configured to
   select a stress estimation model based on the classification and
   input the stress estimation feature values to the selected stress estimation model to estimate a stress value of the estimation target person.

### [Supplementary Note 10]

The stress estimation device according to Supplementary Note 9,
wherein the stress estimation means is configured to estimate the stress value based on a stress estimation model trained by the learning device according to any one of Supplementary Notes 1 to 8.

### [Supplementary Note 11]

The stress estimation device according to Supplementary Note 9 or 10,
wherein the feature value selection means is configured to select, as the stress estimation feature values, observed feature values which fall under a same type as the stress estimation feature values selected by the learning device according to any one of Supplementary Notes 1 to 8.

### [Supplementary Note 12]

The stress estimation device according to any one of Supplementary Notes 9 to 11,
the classification means is configured to classify the observed feature values into plural classes,
wherein the stress estimation means is configured to estimate the stress value by integrating estimation results outputted by plural stress estimation models selected based on the plural classes.

### [Supplementary Note 13]

A learning method executed by a computer, the learning method comprising:
performing a first sorting for sorting observation feature values of a target person based on at least one of an attribute and/or environment of the target person;
performing a second sorting for sorting the observed feature values based on at least one of an observation target of the observed feature values and/or an activity state of the target person;
selecting stress estimation feature values, which are feature values to be used for stress estimation, from the observed feature values sorted based on the first sorting and the second sorting; and
training a stress estimation model based on the stress estimation feature values and stress values that are correct answer corresponding to the stress estimation feature values, at least for each of clusters into which the observed feature values are sorted by the first sorting.

### [Supplementary Note 14]

A stress estimation method a stress estimation method, the stress estimation method comprising:
classifying observed feature values of an estimation target person subject to stress estimation, based on at least one of an attribute and/or an environment of the estimation target person;
selecting stress estimation feature values, which are used for stress estimation, from the observed feature values, based on the classification; and
selecting a stress estimation model based on the classification and inputting the stress estimation feature values to the selected stress estimation model to estimate a stress value of the estimation target person.

### [Supplementary Note 15]

A storage medium storing a program executed by a computer, the program causing the computer to:
perform a first sorting for sorting observation feature values of a target person based on at least one of an attribute and/or environment of the target person;
perform a second sorting for sorting the observed feature values based on at least one of an observation target of the observed feature values and/or an activity state of the target person;
select stress estimation feature values, which are feature values to be used for stress estimation, from the observed feature values sorted based on the first sorting and the second sorting; and
train a stress estimation model based on the stress estimation feature values and stress values that are correct answer corresponding to the stress estimation feature values, at least for each of clusters into which the observed feature values are sorted by the first sorting.

### [Supplementary Note 16]

A storage medium storing a program executed by a computer, the program causing the computer to:
classify observed feature values of an estimation target person subject to stress estimation, based on at least one of an attribute and/or an environment of the estimation target person;
select stress estimation feature values, which are used for stress estimation, from the observed feature values, based on the classification; and
select a stress estimation model based on the classification and input the stress estimation feature values to the selected stress estimation model to estimate a stress value of the estimation target person.

While the invention has been particularly shown and described with reference to example embodiments thereof, the invention is not limited to these example embodiments. It will be understood by those of ordinary skilled in the art that various changes in form and details may be made therein without departing from the spirit and scope of the present invention as defined by the claims. In other words, it is needless to say that the present invention includes various modifications that could be made by a person skilled in the art according to the entire disclosure including the scope of the claims, and the technical philosophy. All Patent and Non-Patent Literatures mentioned in this specification are incorporated by reference in its entirety.

### DESCRIPTION OF REFERENCE NUMERALS

1 Information processing device
1A Stress estimation device
1B, 1BX Learning device
2 Input device
3 Display device
4 Storage device
5 Sensor
8 Terminal device
100, 100A Stress estimation system

What is claimed is:

1. A learning device comprising:
at least one memory configured to store instructions; and
at least one processor configured to execute the instructions to:
perform a first sorting for sorting observation feature values of a target person based on at least one of an attribute and/or environment of the target person;
perform a second sorting for sorting the observed feature values based on at least one of an observation target of the observed feature values and/or an activity state of the target person;
select stress estimation feature values, which are feature values to be used for stress estimation, from the observed feature values sorted based on the first sorting and the second sorting; and
train a stress estimation model based on the stress estimation feature values and stress values that are correct answer corresponding to the stress estimation feature values, at least for each of clusters into which the observed feature values are sorted by the first sorting.

2. The learning device according to claim 1,
wherein the at least one processor is configured to execute the instructions to select the stress estimation feature values, based on a correlation between
the observed feature values sorted based on the first sorting and the second sorting and
the stress values.

3. The learning device according to claim 2,
wherein the at least one processor is configured to execute the instructions to
generate plural groups by random extraction from the observed feature values sorted based on the first sorting and the second sorting, and
select the stress estimation feature values based on an aggregated result, for the plural groups, of the correlation calculated per group.

4. The learning device according to claim 3,
wherein the at least one processor is configured to execute the instructions to calculate, as the aggregation result, the statistical value of the correlations for the plural groups and a ratio of positive/negative signs of the correlations for the plural groups.

5. The learning device according to claim 1,
wherein the at least one processor is configured to execute the instructions to train the stress estimation model for each of clusters into which the observed feature values are sorted by the first sorting and the second sorting.

6. The learning device according to claim 1,
wherein the at least one processor is configured to execute the instructions to output, as a learning result,
the feature value selection information that is information regarding the selected stress estimation feature values and
the parameters of the trained stress estimation model.

7. The learning device according to claim 1,
wherein the at least one processor is configured to execute the instructions to generate pseudo data, which indicates a stress value at a time when the stress values are not measured, by interpolation of the stress values.

8. The learning device according to claim 1,
wherein the at least one processor is configured to execute the instructions to perform the first sorting so that a part of the observed feature values redundantly falls under two or more groups.

9.-12. (canceled)

13. A learning method executed by a computer, the learning method comprising:
performing a first sorting for sorting observation feature values of a target person based on at least one of an attribute and/or environment of the target person;
performing a second sorting for sorting the observed feature values based on at least one of an observation target of the observed feature values and/or an activity state of the target person;
selecting stress estimation feature values, which are feature values to be used for stress estimation, from the observed feature values sorted based on the first sorting and the second sorting; and
training a stress estimation model based on the stress estimation feature values and stress values that are correct answer corresponding to the stress estimation feature values, at least for each of clusters into which the observed feature values are sorted by the first sorting.

14. (canceled)

15. A non-transitory computer readable storage medium storing a program executed by a computer, the program causing the computer to:
perform a first sorting for sorting observation feature values of a target person based on at least one of an attribute and/or environment of the target person;
perform a second sorting for sorting the observed feature values based on at least one of an observation target of the observed feature values and/or an activity state of the target person;
select stress estimation feature values, which are feature values to be used for stress estimation, from the observed feature values sorted based on the first sorting and the second sorting; and
train a stress estimation model based on the stress estimation feature values and stress values that are correct answer corresponding to the stress estimation feature values, at least for each of clusters into which the observed feature values are sorted by the first sorting.

16. (canceled)
